(19) United States
(12) Patent Application Publication
(10) Pub. No.: US 2015/0058055 A1
(43) Pub. Date: Feb. 26, 2015

(54) AUTOMATED COURSE SCHEDULING AND BALANCING SYSTEM AND METHOD

(71) Applicant: American Public University System, Charles Town, WV (US)

(72) Inventors: Brian Blodgett, Bowie, MD (US); Asif Mohammed, Charles Town, WV (US)

(73) Assignee: American Public University System, Charles Town, WV (US)

(21) Appl. No.: 13/973,064

(22) Filed: Aug. 22, 2013

(51) Int. Cl. G06Q 50/20; G06Q 10/06

(52) U.S. Cl. CPC G06Q 50/205; G06Q 10/06311
USPC 705/7.13

(57) ABSTRACT

A scheduling and balancing server operates with data acquired from a scheduler datastore and data from datastores residing in a university server to dynamically generate an annual course rolling schedule and to dynamically place faculty into course sections defined by the annual course rolling schedule.

### BACKGROUND

The phrase “educational institution” typically engenders images of a physical place, perhaps with a tree-lined campus, student dormitories, and a faculty member lecturing before a classroom of students. The Internet has spawned another kind of educational institution, one with a virtual classroom in which students interact with a teacher via a computer. While brick and mortar facilities have not been replaced, the Internet has brought the content of the classroom to the home and office.

The Internet has also changed the way the physical educational institution interacts with students. For example, course registration servers are used by colleges and universities to interact with students. Typically, an enrolling student visits a Web site where that student enters his or her name, selects courses from descriptions displayed on the site, and is advised as to the availability of the course session and the times that it is provided. Network-based course registration provides a student a means to manage class requirements and schedules. From the perspective of the educational institution, network-based course registration is a management tool that automates the registration process and allows limited means for institutions to track course participation by category, subcategory, location, and/or course number.

In a network-based distance-learning environment (herein, a “virtual university”), a student is not only expected to register for classes electronically, but to receive course material, take tests, and obtain guidance via an electronic classroom formed by networking students and an instructor.

While student interactions with a virtual university are largely automated, scheduling of faculty and balancing course offerings remains a manual, labor intensive process that cannot “react” to changes in faculty availability and student needs or apply dynamically rules that determine course loading of faculty and student access to courses.

### SUMMARY

Embodiments herein are directed to systems and methods for tracking and managing course and faculty scheduling requirements and generating an annual course schedule based on historical data. Embodiments are also directed to optimizing faculty scheduling based on business rules, requirements and demand. Embodiments are also directed to controlling the resources displayed to students based on student registration and faculty (full-time and adjunct) scheduling policies.

### DESCRIPTION OF THE DRAWINGS

FIG. 1 illustrates a block diagram of a virtual university according to an embodiment.

FIG. 2 is a block diagram illustrating components of an automated course scheduling and balancing server according to an embodiment.

FIG. 3 is a block diagram illustrating functional components of a personal computer.

FIG. 4 is a block diagram illustrating functional components of a server.

FIGS. 5A, 5B and 5C are block diagrams illustrating processes by which a faculty member is assigned to course or section according to embodiments.

### DETAILED DESCRIPTION

The following applications are incorporated by reference: U.S. application Ser. No. 13/013,922, filed Jan. 26, 2011 and U.S. patent application Ser. No. 11/032,587 filed Jan. 10, 2005. The application Ser. Nos. 13/013,922 and 11/032,587 are hereby incorporated by reference in their entireties for all purposes. Without limiting the foregoing, subject matter from various drawings, and discussions of those drawings, is incorporated herein and may be referenced in the claims.

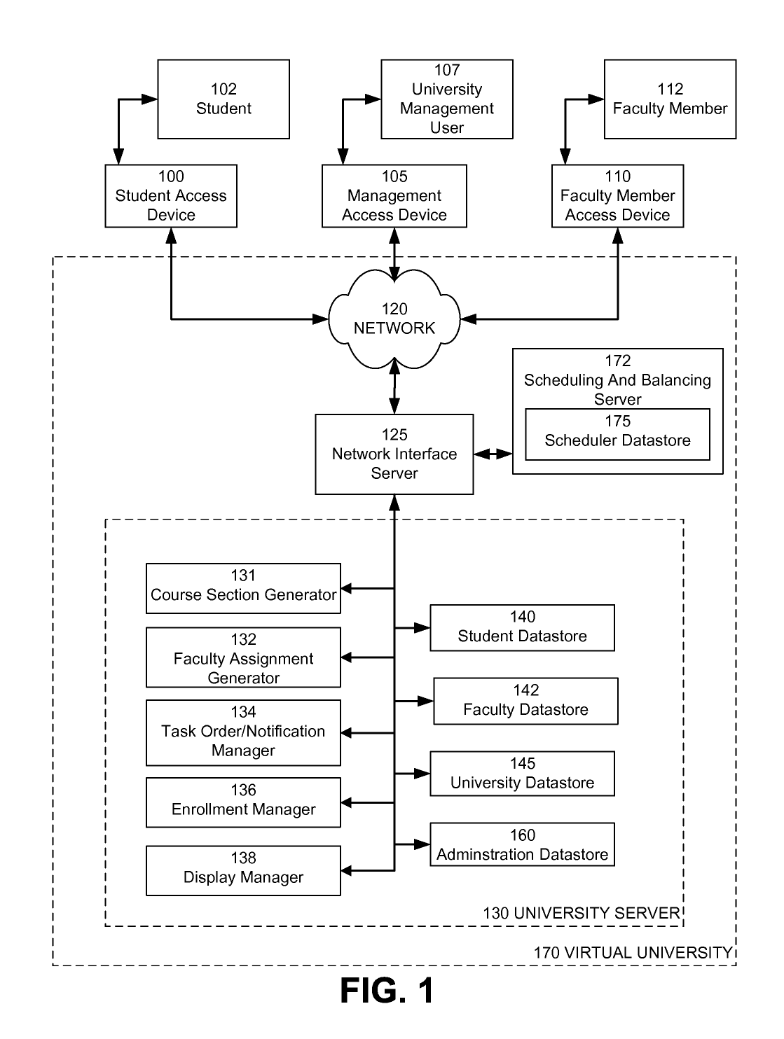

FIG. 1 illustrates a block diagram of a virtual university according to an embodiment. A student access device 100 operated by a student 102, a management access device 105 operated by a university management user 107, and a faculty member 110 access device operated by a faculty member 112 (collectively, “remote users”) each have access to a network interface 125 server via a network 120. The network interface server 125 determines whether a particular remote user may “enter” (access) a virtual university 170 operating on university server 130. By way of illustration, a student 102 presenting the proper credentials may enter the virtual university 170 and access a student record (not shown) in a student datastore 140 pertaining to that student 102 only. A faculty member 112 presenting the proper credentials may enter the virtual university 170 and access those student records in student datastore 140 that pertain to each student 102 enrolled in one or more classes taught by that faculty member 112. A university management user 107 presenting the proper credentials may enter the university and access the scheduling and balancing server (SBS) 172.

In an embodiment, a virtual university 170 comprises a student datastore 140, a faculty datastore 142, a university datastore 145, and an administration datastore 160.

The student datastore 140 comprises a student record pertaining to each student 102. By way of illustration and not by way of limitation, a student record includes classes taken, current class schedule, class performance measures, projected class schedule, personal datastore, and payment datastore.

The faculty datastore 142 comprises a record pertaining to each faculty member 112. By way of illustration and not by way of limitation, a faculty member record includes a status (full time, adjunct, staff), courses that the faculty member may teach, annual work agreement, quotas (such as, for example, a number of students that a full time faculty must teach over the course of the calendar year), concurrent sessions limitations, unique number of courses limitations, number of student limitations, vacation schedule and performance metrics. The values of each of these requirements may be set by an administrator, such as, for example, university management user 107.

University datastore 145 comprises information about the virtual university 170. By way of illustration and not as a limitation, such information includes courses offered, current registrations for particular classes, relationships between classes such a pre- and co-requisites, degree requirements, news, and a contact directory. In an embodiment, the university datastore 145 also captures historical data relating to class offerings, student requirements, and projected growth based on historical trends and data collected from non-university sources.

Administration datastore 160 comprises information relating to the management of the virtual university 170. In an embodiment, the degree plans of all students are evaluated to determine the administrative resources required by the virtual university 170 to fulfill its commitments to its students.

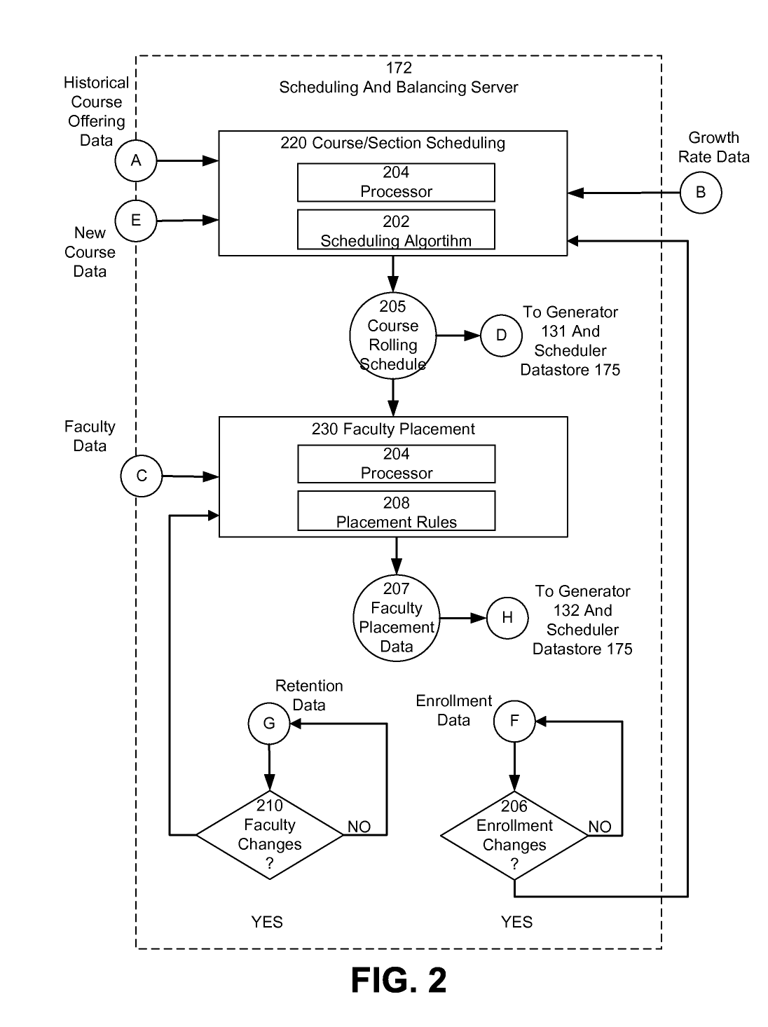

As more fully described below, a scheduling and balancing server (SBS) 172 operates with data acquired from scheduler datastore 175 and data from datastores residing in university server 130 to dynamically generate an annual course rolling schedule (see, FIG. 2, 220) and to dynamically place faculty into course sections defined by the annual course rolling schedule (see, FIG. 2, 230). In embodiments, the SBS 172 may operate to continuously update the annual course rolling schedule data and the faculty placement data. The annual course rolling schedule data (FIG. 2, Circle 205) and the faculty placement data (FIG. 2, Circle 207) are provided to a course section generator 131 (see, FIG. 2, Circle D) and a faculty assignment generator 132 respectively (see, FIG. 2, Circle H). The generators 131 and 132 create course section offers and faculty assignments that are displayed to students and faculty. A display manager 138 utilizes the outputs of the course section generator 131 and the faculty assignment generator 132 to manage the display of the course section offerings to students and faculty. The annual course rolling schedule data (FIG. 2, Circle 205) and the faculty placement data (FIG. 2, Circle 207) are also stored in scheduler datastore 175. (See, FIG. 2, Circles D and H)

FIG. 2 is a block diagram illustrating components of an automated course scheduling and balancing server according to an embodiment.

In an embodiment, a course/section scheduling component 220 of the SBS 172 receives historical data of course offerings by program and by course (Circle A), growth rate data (Circle B) and, optionally, new course data (Circle E) from the university datastore 145 via university server 130 and the network interface server 125. In an embodiment, a processor 204 is configured with a scheduling algorithm 202 that is applied to the historical data (Circle A) and the growth rate data (Circle B) to generate annual course rolling schedule data that includes a number of sections needed per course for each semester start for the upcoming calendar year. By way of illustration and not by way of limitation, the data may be formatted in XML.

By way of illustration and not by way of limitation, predictions of the number of sections needed per courses can be made, for example, using a) course growth prediction, university growth prediction, a measure of past demand, and an exponential moving average prediction. The prediction method may be determined by a university management user 107 determine the prediction method before the scheduling algorithm 202 is applied to the historical data and the growth rate data.

The course rolling schedule data (Circle 205) are provided to a faculty placement component 230 of scheduling and balancing server 172. The faculty placement component 230 also receives faculty data (Circle C) from the university datastore 145 via university server 130 and the network interface server 125.

In an embodiment, a processor 204 is configured with faculty placement rules 208 to generate faculty placement data (Circle 207) that includes an assignment of a faculty member to each course section. By way of illustration and not by way of limitation, the faculty placement data (Circle 207) may be formatted in XML.

The course rolling schedule data (Circle 205) and the faculty placement data (Circle 207) are stored in scheduler datastore 175.

In an embodiment, enrollment data (Circle F) is evaluated (Block 206) to determine whether changes in student enrollment have occurred and whether the changes may impact the course rolling schedule data (Circle 205). If changes in the enrollment data have not occurred, that is, if the result of Block 206 is “NO,” the SBS 172 continues to monitor the enrollment data. If changes in the enrollment data have occurred, that is, if the result of Block 206 is “YES,” the SBS 172 provides the updated enrollment data to the course/section scheduling component 220 and the process of determining the course rolling schedule data (Circle 205) and the faculty placement data (Circle 207) is repeated using the updated enrollment data.

In an embodiment, retention data (Circle G) is evaluated (Block 210) to determine whether changes in faculty availability have occurred and whether the changes may impact the faculty placement data (Circle 207). If changes in faculty availability have not occurred, that is, if the result of Block 210 is “NO,” the SBS 172 continues to monitor the faculty availability. If changes in faculty availability have occurred, that is, if the result of Block 210 is “YES,” the SBS 172 provides the updated faculty data to the faculty placement component 230 and the process of determining the faculty placement data (Circle 207) is repeated using the updated faculty data.

In an embodiment, the scheduler datastore 175 is accessible to authorized users via the network interface server 125 and network 120. In an embodiment, a faculty member, such as faculty member 112 may access the scheduler datastore 175 using a faculty member access device 110. In this embodiment, the faculty member 112 may view the annual course rolling schedule data and the faculty assignments data.

As described above, the faculty placement component 230 uses one or more rules 208 that determine the placement (assignment) of faculty members to the course sections identified in the annual course rolling schedule. The following rules are provided for illustrative purposes only and are not meant to be limiting. Values assigned to variables are also illustrative and not limiting. A rule may include a variable that is adjustable to accommodate changes in policy, changes in student enrollment, changes in faculty and other conditions that impact the scheduling of courses.

TABLE 1
ILLUSTRATIVE FACULTY PLACEMENT RULES

| RULE | |
|---|---|
| NO. | RULE |
| 1. | Full Time Faculty (FTF) must be placed into course sections |
| | before Adjunct Faculty (ADJ) and Staff. FTF should teach 11% |
| | of their annual contract numbers per month. |
| 2. | FTF will be able to teach 10 months out of the calendar year. |
| 3. | FTF can teach up to five percent over their annual work |
| | agreement number, until the hard maximum of 600 is reached |
| | (this 600 is before estimated withdrawals) without approval |
| | through Manual Over Ride. |
| 4. | FTF can teach more than five percent over their annual contract |
| | numbers, after estimated withdrawals, only with manual override |
| | and with Dean and Academic Operations Officer or Provost |
| | approval. |
| 5. | If FTF have met their required monthly percentage of their |
| | annual contract numbers (defined as 11%), then the SBS may |
| | use Adjunct Faculty (ADJ) to teach a course section. |
| 6. | The SBS must only place a faculty into a course that is on the |
| | Approved Faculty Course List unless manual override occurs. |
| 7. | The SBS must not allow a faculty member to be placed into a |
| | course section that would exceed the number of concurrent |
| | sections (a global variable may be used) a faculty member is |
| | allowed to teach at one time. |
| 8. | FTF may teach up to x concurrent sessions. |
| 9. | Adjuncts/Staff may teach up to x concurrent sessions. |
| 10. | The SBS must not allow faculty to be placed into a course |
| | section that would exceed the unique number of courses |
| | (a global variable may be used) a Faculty can teach. |
| 11. | FTF can teach ten unique courses per calendar year. |
| 12. | FTF may teach up to x concurrent unique courses at one time. |
| 13. | Adjuncts can teach ten unique courses per calendar year. |
| 14. | Adjuncts/Staff may teach up to x concurrent unique courses at |
| | one time. |
| 15. | The SBS must not allow faculty to be placed into a course |
| | section that would exceed the maximum number of |
| | session starts (sections) (a global variable may be used) |
| | a Faculty can teach at one time. |
| 16. | FTF may teach x session starts (course sections beginning at the |
| | same time) at one time. |
| 17. | Adjuncts/Staff may teach x session starts (course sections |
| | beginning at the same time) at one time. |
| 18. | The SBS must not allow Faculty to be placed into a course |
| | section that would exceed the maximum number of concurrent |
| | students a faculty should teach at one time. |
| 19. | FTF need to teach 11 percent of their teaching requirement (after |
| | estimated withdrawals) per teaching month. |
| 20. | Adjuncts/Staff do not have a maximum number of students, but |
| | should not exceed 50 (this is a global variable) at any one time |
| | (after estimated withdrawals). |
| 21. | The SBS must not place a faculty member into either an 8 or a |
| | 16 week course section that would cause the faculty member to |
| | teach any portion of that course during their vacation month. |
| 22. | The SBS must not allow faculty to be placed into a projected |
| | course section that would exceed “x” number of simultaneous |
| | students being taught. |
| 23. | Concurrent maximum of scheduled students after drops should |
| | not exceed “x”. |

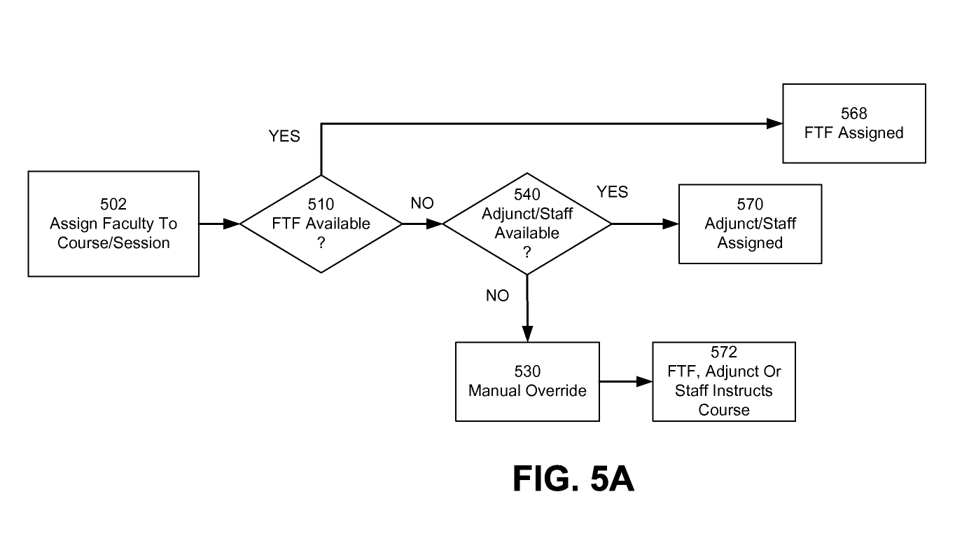

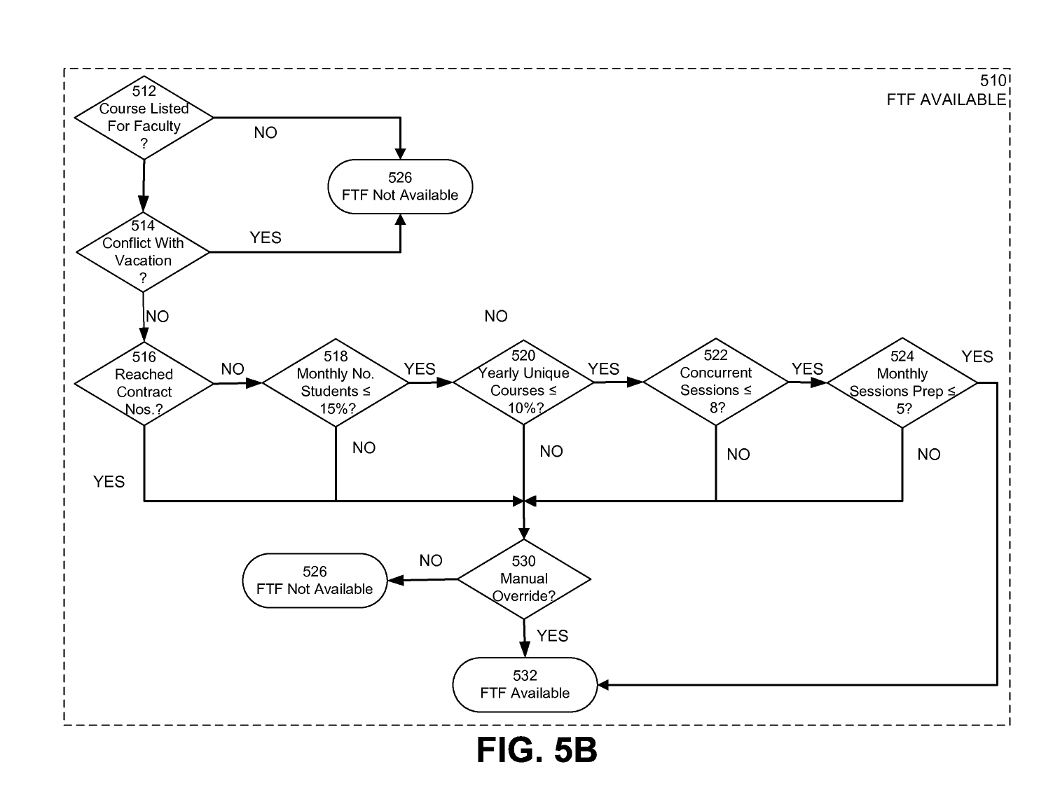

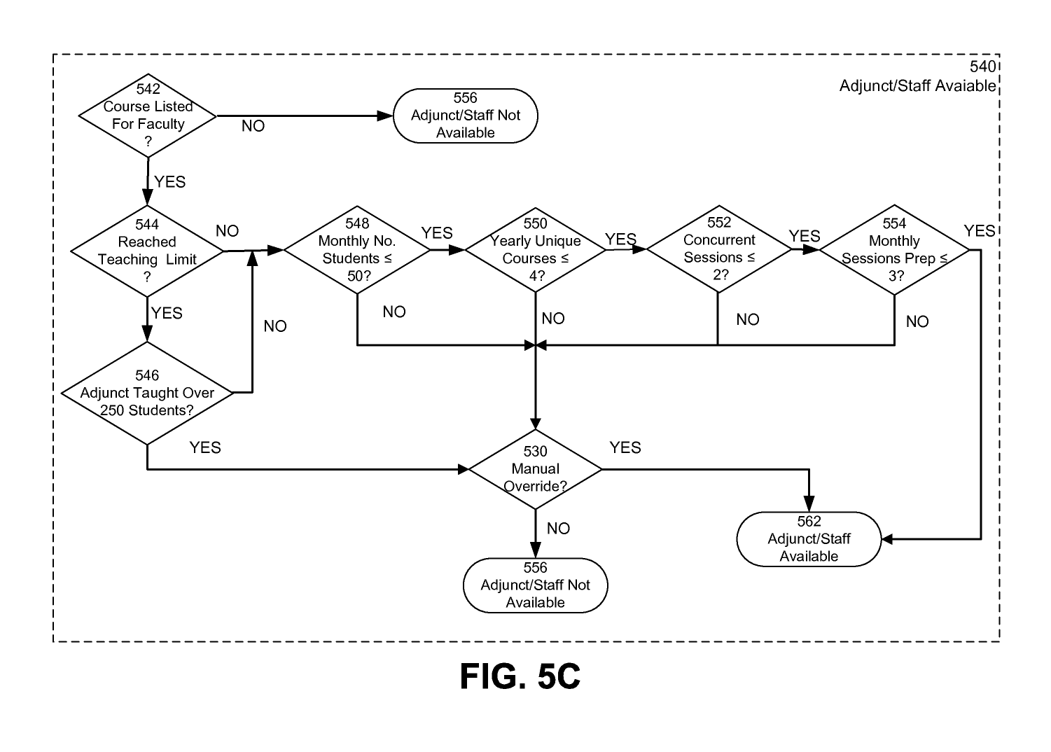

An example of the operations of the faculty placement component 230 is illustrated in FIGS. 5A, 5B and 5C.

At Block 510, a determination is made whether a full-time faculty (FTF) member is available to teach a course/section. If an FTF is available, that is, if the result of Block 510 is “YES,” an FTF is assigned to teach the course/section. If an FTF is not available, that is, if the result of Block 510 is “NO,” a determination is made at Block 540 whether an adjunct or staff member is available to teach the course/section. If an adjunct or staff member is available, that if the result of Block 540 is “YES,” an adjunct or staff member is assigned to teach the course/section (Block 570). If an adjunct or staff member is not available, that is, if the result of Block 540 is “NO,” a determination is made at Block 530 whether to manually assign an FTF, an adjunct or a staff member (Block 572).

FIG. 5B illustrates an exemplary process by which rules, such as one or more of the rules in Table 1, may be applied to determine whether an FTF is available to teach a course/section according to an embodiment.

At Block 512, a determination is made whether a course is listed for an FTF. If a course is not listed for an FTF, that is, if the result of Block 512 is “NO,” the FTF is not available to teach the course/section (Block 526). If an FTF is available, that is, if the result of Block 512 is “YES,” a determination is made at Block 514 whether the course/section schedule would cause a conflict in a vacation rule when applied to the FTF. If the course/section schedule would cause a conflict in a vacation rule when applied to the FTF, that is, if the result of Block 514 is “YES,” the FTF is not available to teach the course/section (Block 526). If the course/section schedule would not cause a conflict in a vacation rule when applied to the FTF, that is, if the result of Block 514 is “NO,” the FTF may be available to teach the course/section, subject to the application of the rules in Blocks 516, 518, 520, 522 and 524. If the results of all of these Blocks is “YES,” the FTF is available. If the results of any of Blocks 516, 518, 520, 522 and 524 is “NO,” that is, if one or more rules are violated, the FTF will be unavailable (Block 526) unless a determination is made at Block 530 to override the violation of the one or more rules.

FIG. 5C illustrates an exemplary process by which rules, such as one or more of the rules in Table 1, may be applied to determine whether an adjunct or staff member is available to teach a course/section when an FTF is not available.

At Block 542, a determination is made whether a course is listed for an adjunct/staff member. If a course is not listed, that is, if the result of Block 512 is “NO,” the adjunct/staff member is not available to teach the course/section (Block 556). If a course is listed for the adjunct/staff member, that is, if the result of Block 542 is “YES,” the adjunct/staff member may be available to teach the course/section, subject to the application of the rules in Blocks 546, 548, 550, 552 and 554. If the result Block 546 is “NO” and the results of Blocks 548, 550, 552, and 554 are “YES,” the adjunct/staff member is available (Block 562). If the result Block 546 is “YES” or the results of any of Blocks 548, 550, 552, and 554 are “NO,” that is, if one or more rules are violated, the adjunct/staff member will be unavailable (Block 562) unless a determination is made at Block 530 to override the violation of the one or more rules.

Referring again to FIG. 2, in an embodiment, the annual rolling schedule data produced by the SBS 172 are provided to a course section generator 131 (Circle D). The data may be pushed to, or requested by, the course section generator. By way of illustration and not by way of limitation, the data may be formatted in XML. The course section generator 131 uses the annual rolling schedule data to generate the course sections to offered to students.

In an embodiment, the faculty placement data produced by the SBS 172 are provided to a faculty assignment generator 132 (Circle H). The data may be pushed to or requested by the faculty assignment generator 132. By way of illustration and not by way of limitation, the data may be formatted in XML. The faculty assignment generator 132 uses the faculty assignment data to assign faculty members to teach course sections.

In an embodiment, a task order/notification manager 134 sends a task order to each faculty member who has been assigned to teach a course section. The task order may be sent by email, text or other media. The faculty member 112 may access this information by accessing faculty member access device 110. In an embodiment, the faculty member to whom the task order is sent must accept an assignment with a period of time, for example, within forty-eight hours or seventy-two hours. In another embodiment, the acceptance period may change as the start of class is approached. In still another embodiment, the acceptance period may be changed by a university management user 107.

If an acceptance is not received with the time period, the task order is withdrawn and the course section is reassigned. In an embodiment, the task order/notification manager 134 may notify the faculty member that the previously issued task order has been rescinded. In another embodiment, the status of each task order is maintained by the task order/notification manager 134. For example, a status may be identified as accepted, declined or pending.

In an embodiment, when a task order is accepted, declined or withdrawn, the task order/notification manager 134 communicates the task order status to the SBS 172. If the task order status is accepted, the SBS will confirm the faculty placement. If the task order is declined or expired, the SBS will reapply the placement algorithm to assign a different faculty member to the section based on the scheduling business rules and will generate revised faculty assignment data for use by the faculty assignment generator 132.

In an embodiment, if the task order is declined or pending, and a previous task order has been accepted for another section of the same course, an enrollment manager 136 will allow students to continue to register for that section which has the accepted task order, even if the maximum enrollment has been reached. In an embodiment, when sections for which a task order is declined or pending are updated to “accepted,” students in the “overenrolled” section will be moved into the new section by the SBS 172.

In an embodiment, when the faculty datastore 142 is updated, the updated faculty data is pushed to the SBS 172 before a course starts. (See, FIG. 2, Block 210). In this situation, the SBS applies the placement algorithm 208 in accordance with the placement rules (see, for example, Table 1) to the updated faculty data to produce updated faculty assignment data. The update faculty assignment data are provided to the faculty assignment generator 132. The data may be pushed to or requested by the faculty assignment generator 132. By way of illustration and not by way of limitation, the data may be formatted in XML. The faculty assignment generator 132 uses the updated faculty assignment data to assign faculty members to teach course sections as previously described. The task order/notification manager 134 sends a task order to the newly assigned faculty member as previously described.

Circumstances may arise in which a faculty member must be replaced after a course has started. In an embodiment, the faculty assignment generator 132 may be accessed by a university management user 107 to manually assign a faculty member to a course section.

In an embodiment, the task order/notification manager 134 may also be configured to send notification to students who have enrolled in a class of a change of instructors.

In another embodiment, the enrollment manager 136 monitors actual student enrollment in course offerings. (See, FIG. 2, Block 206.) Enrollment data may be pushed to or requested by the SBS 172 (FIG. 2, Circle F). By way of illustration and not by way of limitation, the data may be formatted in XML. The scheduling algorithm 202 may be applied to the enrollment data to identify course sections with no students or with too few students and to cancel those course sections. In an embodiment, the task order/notification manager 134 may also be configured to send notification to a faculty member whose schedule course section has been canceled. A notification may also be sent to one or more university management user 107.

In an embodiment, a course with too few students will not be cancelled if it is the only section. If there are not enough students to comprise a section, which is determined by a global variable, then the students will be moved to another section as long as the other section does not have students in excess of the recommended amount of students per section.

For courses in which multiple course sections have been opened, the SBS 172 may use the enrollment data to balance registrations. For example, the scheduling algorithm 202 may evaluate all course sections against a minimum registration threshold. Balancing rules may be applied to sections with students that do not meet the threshold to reassign students to other course sections.

The following rules are provided for illustrative purposes only and are not meant to be limiting. Values assigned to variables are also illustrative and not limiting:

TABLE 2
ILLUSTRATIVE BALANCING RULES

| RULE | |
|---|---|
| NO. | RULE |
| 1. | FTF always get preference of additional students unless they |
| | would violate the following Scheduling Business Rules: (1) |
| | FTF may teach x session starts (course sections) at one |
| | time or (2) Student count can be five percent over the |
| | individual FTF's yearly teaching limit after estimated |
| | withdraws. |
| 2. | If two FTF are teaching the same course, the instructor with |
| | lowest percent of students taught to date should receive |
| | the additional students. |
| 3. | If two or more Adjuncts are teaching the same course, the |
| | one with lowest percent of students should receive the |
| | additional students unless they would violate the following |
| | Scheduling Business Rule: (1) Adjuncts/Staff may teach x |
| | session starts (course sections) at one time. |
| 4. | Manual override by faculty if needed |

In an embodiment, application of the balancing rules after registration has closed may require students in a cancelled section to be moved to another section. The scheduling algorithm 202 may be applied to enrollment data (Circle F) to determine an optimized total student count for each course section and a number of student to be moved from canceled section A to sections B and C. The updated course rolling data (Circle 205) may be provided to the section generator 131 (Circle D). The section generator 131 will then reassign specific students to section B and C. The reassignment may be random or based on an algorithm. For example, the section generator 131 may move a student who was the last to register. In an embodiment, the task order/notification manager 134 may also be configured to send notification to students who have enrolled in a class of a change of instructors.

In an embodiment, the course section offerings that are produced by course section generator 131 are displayed to students according to display rules executed by a display manager 138. The display manager 138 may limit the number of sections that are displayed to students for registration.

In an embodiment, the display manager 138 may be configured by a university management user, such as university management user 107, to establish for each course a first maximum number of course sections that may be displayed. In another embodiment, the only course sections for which a faculty member has accepted a task order will be displayed.

In an embodiment, the display manager 138 may be configured by a university management user, such as university management user 107, to establish a period of time before registration ends during which the first maximum number of course sections may be overridden by a user-configurable second maximum number of course sections.

In an embodiment, the placement data provided by the SBS 172 includes a listing of course sections that are ordered according to a priority measure associated with each of the assigned faculty members. The display manager 138 will display the course section having the highest priority up to the value in the first maximum or second maximum number of course sections (as appropriate).

In another embodiment, the task order manager 132 may notify a faculty member that his or her section is now on display for student registration. In an embodiment, once the maximum enrollment limit has been met for the current section(s) being displayed, the display manager 138 may display a new section or group of sections based on the first maximum or second maximum number of course sections (as appropriate). In an embodiment, the sections or group of sections that have reached a maximum enrollment limit will no longer be displayed. In embodiment, the SBS 172 initially adjusts the limit of students able to enroll in a section based on historical retention data. If data generated by the scheduling algorithm 202 produces data indicating that the historical retention data does reflect the current retention, then the SBS 172 may adjust the limit accordingly. (FIG. 2, Circle G.)

In an embodiment, when a change in the assignment of a section to a faculty member changes, the priority of the section may change. Thus, even if students have already enrolled in such a section, the section may not be displayed if the first maximum or second maximum number of course sections (as appropriate) has been reached using higher priority sections.

In still another embodiment, the display manager 138 may be configured to always make available at least one section of a course for student registration so long as there is an accepted task order. For example, if an enrollment limit for a course section is met and there is no other section available for registration, that course section will remain open and will be displayed without regard to the enrollment limit.

In an embodiment, the display manager 138 may be configured for each course to allow or prevent the name of the faculty member assigned to a section of that course to be displayed to students when registering for a course section.

In an embodiment, if an enrollment limit for a course section is met, and there is no other section available for registration, that course section will remain open and will be displayed without regard to the enrollment limit. In an embodiment, the SBS 172 determines when a new course section is required and assigns faculty to the new course section as previously described. In an embodiment, the SBS 172 determines that a new section must be created when the registration in the current course sections has reached a preset percentage of the overall remaining course capacity. Once the task order is accepted, the display manager 138 will determine whether to display the new section based on the display rules as previously described. Alternatively or in addition, the maximum enrollment limit caps for sections with the course may be raised.

In still another embodiment, the preset percentage threshold may vary based on the time remaining before closing registration.

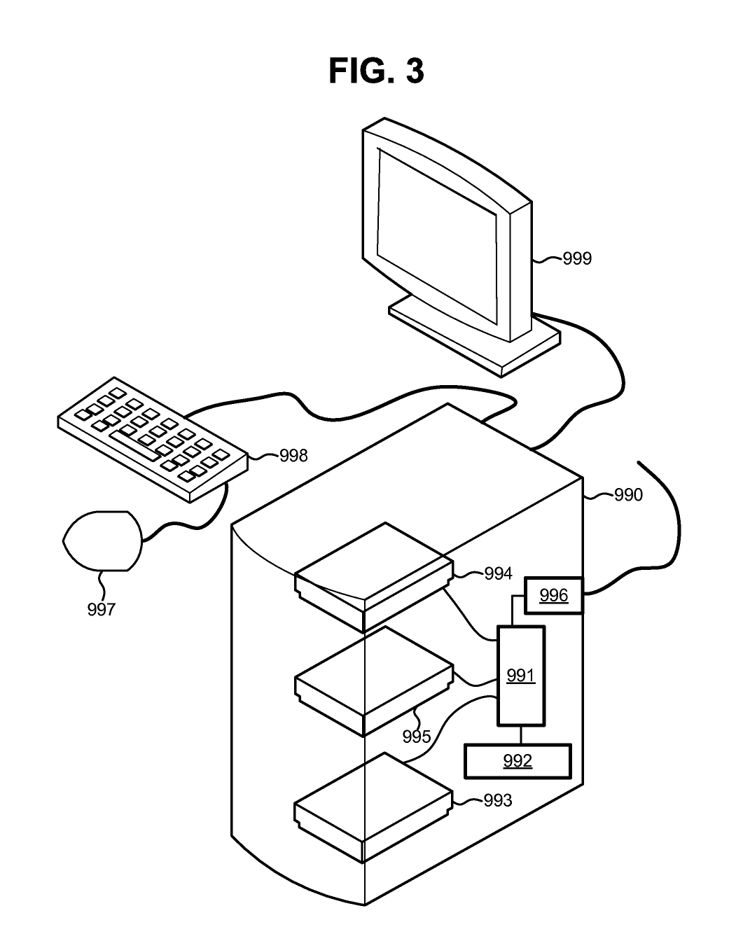

The various determinations, computations and operations may be performed using a processor executing software instructions. For example, the processor of a personal computer may be used for this purpose. By way of illustration, the functional components of a personal computer 990 are illustrated in FIG. 3. Such a personal computer 990 typically includes a processor 991 coupled to volatile memory 992 and a large capacity nonvolatile memory, such as a disk drive 993. The computer 990 may also include a floppy disc drive 994 and a compact disc (CD) drive 995 coupled to the processor 991. Typically the computer device 990 will also include a pointing device such as a mouse 997, a user input device such as a keyboard 998 and a display 999. The computer device 990 may also include a number of connector ports coupled to the processor 991 for establishing data connections or receiving external memory devices, such as USB or FireWire® connector sockets or other network connection circuits 996 for coupling the processor 991 to a network. The computer housing may include the pointing device 997, keyboard 998 and the display 999 as is well known in the computer arts.

The personal computer may be configured as a desktop computer, a laptop computer, a tablet or a smart phone. The functions assigned to student access device 100, management access device 105 and faculty member access device 110 may be performed using a personal computer having some or all of the functional components of personal computer 990.

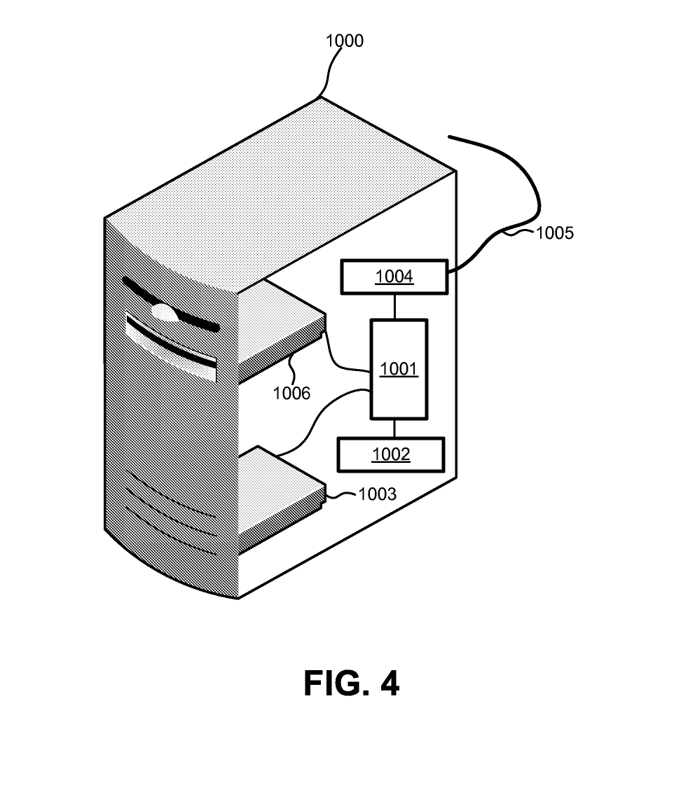

A number of the aspects described above may also be implemented with any of a variety of remote server devices, such as the server 1000 illustrated in FIG. 4. Such a server 1000 typically includes a processor 1001 coupled to volatile memory 1002 and a large capacity nonvolatile memory, such as a disk drive 1003. The server 1000 may also include a floppy disk drive and/or a compact disc (CD) drive 1006 coupled to the processor 1001. The server 1000 may also include a number of connector ports 1004 coupled to the processor 1001 for establishing data connections with network circuits 1005. When used herein, the term “server” refers to a hardware device unless otherwise stated.

The functions assigned to university server 130 and SBS 172 may be performed using a server having some or all of the functional components of server 1000.

While blocks 131, 132, 134, 136 and 138 are illustrated as contained within the university server 130, the drawing is not meant to be limiting. The functions assigned to any one or all of these functional elements may be performed by a personal computer device, such as the personal computer 990 or by a server device, such as the server 1000.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of the computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a computer-readable medium. Computer-readable media include both computer storage media and communication media including any medium that facilitates transfer of a computer program from one place to another. Storage media may be any available media that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of media. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein. Further, any reference to claim elements in the singular, for example, using the articles “a,” “an,” or “the,” is not to be construed as limiting the element to the singular.

What is claimed is:

1. A method for managing course section offerings, the method comprising:
creating by a processor one or more course section offerings;
applying by the processor one or more rules to assign a faculty member to teach a particular course section offering;
sending by the processor a task order to the faculty member, wherein the task order comprises a request for confirmation of the assignment of the particular course section offering; and
permitting by the processor enrollment in the particular section when the faculty member confirms the assignment.

2. The method of claim 1, wherein applying by the processor one or more rules to assign a faculty member to teach a particular course section offering comprises:
applying a first set of rules to determine whether a full time faculty member is available to teach the particular course offering;
assigning the full time faculty member to the course offering when the full time faculty member is available according to the first set of rules; and
assigning an adjunct faculty member to the course offering according to a second set of rules when the full time faculty member is not available according to the first set of rules.

3. The method of claim 2, wherein applying by the processor a first set of rule comprises applying by the processor one or more rules selected from the group consisting of a rule limiting a aggregated period of time within a year that the full time faculty member may teach; a rule limiting the number of concurrent sections that the full time faculty member may teach; a rule measuring a workload of the full time faculty member against a contract commitment of the full time faculty member; and a rule limiting the number of concurrent unique courses that the full time faculty member may teach.

4. The method of claim 2, wherein assigning an adjunct faculty member to the course offering according to a second set of rules comprises applying by the processor one or more rules selected from the group consisting of a rule limiting an aggregated period of time within a year that the adjunct faculty member may teach; a rule limiting the number of concurrent sections that the adjunct faculty member may teach; a rule measuring a workload of the adjunct faculty member against a contract commitment of the adjunct faculty member; and a rule limiting the number of concurrent unique courses that the adjunct faculty member may teach.

5. The method of claim 1 further comprising:
determining by the processor when enrollment in the particular course section offering reaches a maximum value; and
assigning by the processor a second faculty member to a second course section offering when the first section is fully subscribed.

6. The method of claim 1 further comprising:
determining by the processor when enrollment in the particular course section offering is less than a minimum value;
determining by the processor that the particular course section offering is not the only course section offering; and
canceling the particular course section when enrollment in the particular course section offering is less than a minimum value and the particular course section offering is not the only course section offering.

7. The method of claim 6 further comprising:
determining by the processor a total count of students registered for the canceled course section and other course sections; and
reassigning selected students registered for the canceled course section and the other course sections to the other course sections.

8. The method of claim 7, wherein reassigning selected students comprises reassigning a student who was last to register.
